(19) United States
(12) Patent Application Publication
(10) Pub. No.: US 2024/0292446 A1
(43) Pub. Date: Aug. 29, 2024

(54) METHOD AND DEVICE USED FOR WIRELESS COMMUNICATION

(71) Applicant: Xiaobo ZHANG, Shanghai (CN)

(72) Inventor: Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 18/659,012

(22) Filed: May 9, 2024

Related U.S. Application Data
(63) Continuation of application No. PCT/CN2022/131019, filed on Nov. 10, 2022.

(30) Foreign Application Priority Data
Nov. 11, 2021 (CN) 202111332406.6

(51) Int. Cl. H04W 72/541; H04B 17/345

(52) U.S. Cl. CPC H04W 72/541; H04B 17/345

(57) ABSTRACT

The present application discloses a method and a device for wireless communications. A first node receives first information and transmits a first measurement information set; where the first information indicates at least a first time-frequency resource set and a second time-frequency resource set, the first time-frequency resource set comprising at least a target first-type time-frequency resource and the second time-frequency resource set comprising multiple second-type time-frequency resources, and the first measurement information set comprising at least a first resource indicator, a second resource indicator and a first CQI; this application can improve transmission efficiency and reduce redundancy overhead.

### CROSS REFERENCE TO RELATED APPLICATIONS

This application is the continuation of the international patent application No. PCT/CN2022/131019, filed on Nov. 10,2022, and claims the priority benefit of Chinese Patent Application No.202111332406.6, filed on Nov. 11,2021, the full disclosure of which is incorporated herein by reference.

### BACKGROUND

### Technical Field

The present application relates to methods and devices in wireless communication systems, and in particular to a scheme and device for Channel Status Information (CSI) in a wireless communication system.

### Related Art

In traditional wireless communication, the base station selects a suitable Modulation and Coding Scheme (MCS) for the UE based on the Channel Status Information (CSI) reported by the UE (i.e., User Equipment), and notifies the selected MCS to the UE by means of downlink signaling so that the UE can demodulate Transport Blocks (TBs) based on the MCS.

### SUMMARY

CQI (i.e., Channel Quality Indicator) is a type of CSI; in traditional CQI methods, resources for channel measurements (e.g., CSI-Resource) and resources for interference measurements (e.g., CSI-Resource) have one-to-one correspondence. The inventors found through researches that for a given channel measurement resource, if a base station wants to obtain channel status information under multiple interference assumptions, it requires the UE to feedback multiple CQIs, which wastes air-interface resources.

To address the above problem, the present application provides a solution. It should be noted that while a large number of embodiments of the present application are illustrated with respect to inter-base station collaboration, the present application can also be used for traditional intra-base station writing schemes. Further, the use of a unified CSI scheme can reduce implementation complexity or improve performance. It should be noted that if no conflict is incurred, embodiments in any node in the present application and the characteristics of the embodiments are also applicable to any other node, and vice versa. What's more, the embodiments in the present application and the characteristics in the embodiments can be arbitrarily combined if there is no conflict.

The present application provides a method in a first node for wireless communications, comprising:
receiving first information, the first information indicating at least a first time-frequency resource set and a second time-frequency resource set, where the first time-frequency resource set comprises at least a target first-type time-frequency resource and the second time-frequency resource set comprises multiple second-type time-frequency resources; and
transmitting a first measurement information set, the first measurement information set comprising at least a first resource indicator, a second resource indicator and a first CQI;
herein, the first resource indicator is used to indicate the target first-type time-frequency resource, while the second resource indicator is used to indicate a second time-frequency resource subset, the second time-frequency resource subset comprising at least one second-type time-frequency resource, any second-type time-frequency resource in the second time-frequency resource subset belonging to the second time-frequency resource set; a channel measurement performed on the target first-type time-frequency resource is used to calculate the first CQI, and an interference measurement performed on at least one second-type time-frequency resource in the second time-frequency resource set other than the second time-frequency resource subset is used to calculate the first CQI; a cell with which any first-type time-frequency resource in the first time-frequency resource set is associated is different from a cell with which any second-type time-frequency resource in the second time-frequency resource set is associated.

In one embodiment, the above method reduces the overhead of air interface resources caused by the first measurement information set and improves transmission efficiency.

In one embodiment, the above method helps to achieve tighter inter-cell collaboration, reduced interference, and increased throughput.

Specifically, according to one aspect of the present application, the above method is characterized in comprising:
determining a target second-type time-frequency resource out of second-type time-frequency resources in the second time-frequency resource set other than the second time-frequency resource subset;
herein, an interference measurement performed on only the target second-type time-frequency resource among multiple second-type time-frequency resources in the second time-frequency resource set other than the second time-frequency resource subset is used to calculate the first CQI.

In one embodiment, the above method reduces the overhead over air interface and increases the feedback efficiency.

Specifically, according to one aspect of the present application, the above method is characterized in that the first information indicates a third time-frequency resource set, the third time-frequency resource set comprising at least a target third-type time-frequency resource, the target first-type time-frequency resource being associated with the target third-type time-frequency resource; an interference measurement performed on the target third-type time-frequency resource is used to calculate the first CQI.

In one embodiment, a cell with which at least one first-type time-frequency resource in the first time-frequency resource set is associated is the same as a cell with which at least one second-type time-frequency resource in the second time-frequency resource set is associated.

Specifically, according to one aspect of the present application, the above method is characterized in that a second-type time-frequency resource where a strongest amount of interference is measured is selected from second-type time-frequency resources in the second time-frequency resource set other than the second time-frequency resource subset as the target second-type time-frequency resource.

In one embodiment, the above method improves the robustness of downlink scheduling and minimizes the BLock Error Rate (BLER).

Specifically, according to one aspect of the present application, the above method is characterized in comprising:
the first receiver, determining a second time-frequency resource subset from the second time-frequency resource set.

In one embodiment, the above method is capable of avoiding interference in a particular direction.

Specifically, according to one aspect of the present application, the above method is characterized in that the second resource indicator is used to generate the first backhaul signaling, the first backhaul signaling being used to avoid an interference measured in the second time-frequency resource subset on a fourth time-frequency resource set.

Specifically, according to one aspect of the present application, the above method is characterized in comprising:
receiving a first radio signal in the fourth time-frequency resource set;
herein, an interference that the first radio signal undergoes is unrelated to the interference measured in the second time-frequency resource subset.

The above method is capable of improving the transmission robustness, or spectral efficiency, of the first radio signal.

In one embodiment, the first CQI is used to determine an MCS of the first radio signal.

The present application provides a method in a second node for wireless communications, comprising:
transmitting first information, the first information indicating at least a first time-frequency resource set and a second time-frequency resource set, where the first time-frequency resource set comprises at least a target first-type time-frequency resource and the second time-frequency resource set comprises multiple second-type time-frequency resources; and
receiving a first measurement information set, the first measurement information set comprising at least a first resource indicator, a second resource indicator and a first CQI;
herein, the first resource indicator is used to indicate the target first-type time-frequency resource, while the second resource indicator is used to indicate a second time-frequency resource subset, the second time-frequency resource subset comprising at least one second-type time-frequency resource, any second-type time-frequency resource in the second time-frequency resource subset belonging to the second time-frequency resource set; a channel measurement performed on the target first-type time-frequency resource is used to calculate the first CQI, and an interference measurement performed on at least one second-type time-frequency resource in the second time-frequency resource set other than the second time-frequency resource subset is used to calculate the first CQI; a cell with which any first-type time-frequency resource in the first time-frequency resource set is associated is different from a cell with which any second-type time-frequency resource in the second time-frequency resource set is associated.

Specifically, according to one aspect of the present application, the above method is characterized in comprising:
transmitting a first backhaul signaling via an air interface;
herein, the second resource indicator is used to generate the first backhaul signaling, the first backhaul signaling being used to avoid an interference measured in the second time-frequency resource subset on a fourth time-frequency resource set.

The above method improves the speed of interaction between the second node and the receiver of the first backhaul signaling and reduces interference as compared to communicating over a wire.

Specifically, according to one aspect of the present application, the above method is characterized in comprising:
receiving a second backhaul signaling via an air interface;
herein, the second backhaul signaling is used to acknowledge avoidance of the interference measured in the second time-frequency resource subset on the fourth time-frequency resource set.

Specifically, according to one aspect of the present application, the above method is characterized in comprising:
transmitting a first radio signal in the fourth time-frequency resource set;
herein, an interference that the first radio signal undergoes is unrelated to the interference measured in the second time-frequency resource subset.

Ruling out the specific interference, the above method is capable of significantly improving the reception performance of the first radio signal.

Specifically, according to one aspect of the present application, the above method is characterized in that an interference measurement performed on only the target second-type time-frequency resource among multiple second-type time-frequency resources in the second time-frequency resource set other than the second time-frequency resource subset is used to calculate the first CQI.

Specifically, according to one aspect of the present application, the above method is characterized in that a second-type time-frequency resource where a strongest amount of interference is measured is selected from second-type time-frequency resources in the second time-frequency resource set other than the second time-frequency resource subset as the target second-type time-frequency resource.

Specifically, according to one aspect of the present application, the above method is characterized in comprising: determining a target second-type time-frequency resource out of second-type time-frequency resources in the second time-frequency resource set other than the second time-frequency resource subset;

Specifically, according to one aspect of the present application, the above method is characterized in that the first information indicates a third time-frequency resource set, the third time-frequency resource set comprising at least a target third-type time-frequency resource, the target first-type time-frequency resource being associated with the target third-type time-frequency resource; an interference measurement performed on the target third-type time-frequency resource is used to calculate the first CQI.

The present application provides a method in a third node for wireless communications, comprising:
receiving a first backhaul signaling via an air interface;
herein, a second resource indicator is used to generate the first backhaul signaling, the first backhaul signaling being used to avoid an interference measured in the second time-frequency resource subset on a fourth time-frequency resource set; the second resource indicator is used to indicate a second time-frequency resource subset, the second time-frequency resource subset comprising at least one second-type time-frequency resource, any second-type time-frequency resource in the second time-frequency resource subset belonging to a second time-frequency resource set; the second resource indicator belongs to a first measurement information set, the first measurement information set comprising at least a first resource indicator and a first CQI; the first resource indicator is used to indicate a target first-type time-frequency resource, a channel measurement performed on the target first-type time-frequency resource is used to calculate the first CQI, and an interference measurement performed on at least one second-type time-frequency resource in the second time-frequency resource set other than the second time-frequency resource subset is used to calculate the first CQI; the target first-type time-frequency resource belongs to the first time-frequency resource set; a cell with which any first-type time-frequency resource in the first time-frequency resource set is associated is different from a cell with which any second-type time-frequency resource in the second time-frequency resource set is associated.

Specifically, according to one aspect of the present application, the above method is characterized in comprising:
transmitting a second backhaul signaling via an air interface;
herein, the second backhaul signaling is used to acknowledge avoidance of the interference measured in the second time-frequency resource subset on the fourth time-frequency resource set.

Specifically, according to one aspect of the present application, the above method is characterized in comprising:
avoiding in the fourth time-frequency resource set a usage of a transmission parameter that is QCL with any second-type time-frequency resource in the second time-frequency resource subset.

The present application provides a first node for wireless communications, comprising:
a first receiver, receiving first information, the first information indicating at least a first time-frequency resource set and a second time-frequency resource set, where the first time-frequency resource set comprises at least a target first-type time-frequency resource and the second time-frequency resource set comprises multiple second-type time-frequency resources; and
a first transmitter, transmitting a first measurement information set, the first measurement information set comprising at least a first resource indicator, a second resource indicator and a first CQI;
herein, the first resource indicator is used to indicate the target first-type time-frequency resource, while the second resource indicator is used to indicate a second time-frequency resource subset, the second time-frequency resource subset comprising at least one second-type time-frequency resource, any second-type time-frequency resource in the second time-frequency resource subset belonging to the second time-frequency resource set; a channel measurement performed on the target first-type time-frequency resource is used to calculate the first CQI, and an interference measurement performed on at least one second-type time-frequency resource in the second time-frequency resource set other than the second time-frequency resource subset is used to calculate the first CQI; a cell with which any first-type time-frequency resource in the first time-frequency resource set is associated is different from a cell with which any second-type time-frequency resource in the second time-frequency resource set is associated.

The present application provides a second node for wireless communications, comprising:
a second transmitter, transmitting first information, the first information indicating at least a first time-frequency resource set and a second time-frequency resource set, where the first time-frequency resource set comprises at least a target first-type time-frequency resource and the second time-frequency resource set comprises multiple second-type time-frequency resources; and
a second receiver, receiving a first measurement information set, the first measurement information set comprising at least a first resource indicator, a second resource indicator and a first CQI;
herein, the first resource indicator is used to indicate the target first-type time-frequency resource, while the second resource indicator is used to indicate a second time-frequency resource subset, the second time-frequency resource subset comprising at least one second-type time-frequency resource, any second-type time-frequency resource in the second time-frequency resource subset belonging to the second time-frequency resource set; a channel measurement performed on the target first-type time-frequency resource is used to calculate the first CQI, and an interference measurement performed on at least one second-type time-frequency resource in the second time-frequency resource set other than the second time-frequency resource subset is used to calculate the first CQI; a cell with which any first-type time-frequency resource in the first time-frequency resource set is associated is different from a cell with which any second-type time-frequency resource in the second time-frequency resource set is associated.

The present application provides a third node for wireless communications, comprising:
a third receiver, receiving a first backhaul signaling via an air interface;
herein, a second resource indicator is used to generate the first backhaul signaling, the first backhaul signaling being used to avoid an interference measured in the second time-frequency resource subset on a fourth time-frequency resource set; the second resource indicator is used to indicate a second time-frequency resource subset, the second time-frequency resource subset comprising at least one second-type time-frequency resource, any second-type time-frequency resource in the second time-frequency resource subset belonging to a second time-frequency resource set; the second resource indicator belongs to a first measurement information set, the first measurement information set comprising at least a first resource indicator and a first CQI; the first resource indicator is used to indicate a target first-type time-frequency resource, a channel measurement performed on the target first-type time-frequency resource is used to calculate the first CQI, and an interference measurement performed on at least one second-type time-frequency resource in the second time-frequency resource set other than the second time-frequency resource subset is used to calculate the first CQI; the target first-type time-frequency resource belongs to the first time-frequency resource set; a cell with which any first-type time-frequency resource in the first time-frequency resource set is associated is different from a cell with which any second-type time-frequency resource in the second time-frequency resource set is associated.

### BRIEF DESCRIPTION OF THE DRAWINGS

Other features, objects and advantages of the present invention will become more apparent from the detailed description of non-restrictive embodiments taken in conjunction with the following drawings:

FIG. 1 illustrates a flowchart of transmitting first measurement information according to one embodiment of the present application.

FIG. 2 illustrates a schematic diagram of a network architecture according to one embodiment of the present application.

FIG. 3 illustrates a schematic diagram of a radio protocol architecture of a user plane and a control plane according to one embodiment of the present application.

FIG. 4 illustrates a schematic diagram of hardcore modules in a communication node according to one embodiment of the present application.

FIG. 5 illustrates a flowchart of transmissions between a first node, a second node and a third node according to one embodiment of the present application.

FIG. 6 illustrates a schematic diagram of determining a target second-type time-frequency resource according to one embodiment of the present application.

FIG. 7 illustrates a schematic diagram of CQI calculation according to one embodiment of the present application.

FIG. 8 illustrates a schematic diagram of backhaul signaling according to one embodiment of the present application.

FIG. 9 illustrates a structure block diagram of a processing device used in a first node according to one embodiment of the present application.

FIG. 10 illustrates a structure block diagram of a processing device used in a second node according to one embodiment of the present application.

FIG. 11 illustrates a structure block diagram of a processing device used in a third node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

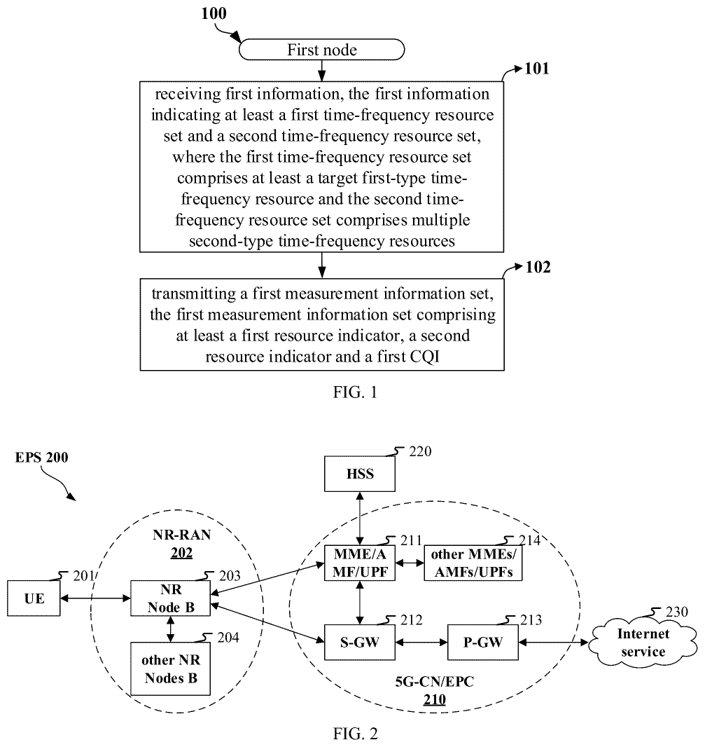

Embodiment 1 illustrates a flowchart of transmitting first measurement information according to one embodiment of the present application, as shown in FIG. 1.

In Embodiment 1, the first node 100 receives first information in step 101, the first information indicating at least a first time-frequency resource set and a second time-frequency resource set, where the first time-frequency resource set comprises at least a target first-type time-frequency resource and the second time-frequency resource set comprises multiple second-type time-frequency resources; and transmits a first measurement information set in step S102, the first measurement information set comprising at least a first resource indicator, a second resource indicator and a first CQI.

In Embodiment 1, the first resource indicator is used to indicate the target first-type time-frequency resource, while the second resource indicator is used to indicate a second time-frequency resource subset, the second time-frequency resource subset comprising at least one second-type time-frequency resource, any second-type time-frequency resource in the second time-frequency resource subset belonging to the second time-frequency resource set; a channel measurement performed on the target first-type time-frequency resource is used to calculate the first CQI, and an interference measurement performed on at least one second-type time-frequency resource in the second time-frequency resource set other than the second time-frequency resource subset is used to calculate the first CQI; a cell with which any first-type time-frequency resource in the first time-frequency resource set is associated is different from a cell with which any second-type time-frequency resource in the second time-frequency resource set is associated.

In one embodiment, a cell with which any first-type time-frequency resource in the first time-frequency resource set is associated and a cell with which any second-type time-frequency resource in the second time-frequency resource set is associated are respectively maintained by two different nodes.

In one embodiment, any one of the two different nodes is a gNB.

In one embodiment, any one of the two different nodes is a NG Radio Access Network (NG-RAN) node.

In one embodiment, the two different nodes are connected to each other via at least Xn interface.

The three embodiments described above are advantageous in reducing the interference between base stations and significantly improving the transmission efficiency of the system as a whole (and in particular of terminals at the edge of a cell).

In one embodiment, a cell with which any first-type time-frequency resource in the first time-frequency resource set is associated and a cell with which any second-type time-frequency resource in the second time-frequency resource set is associated are respectively maintained by the second node and the third node.

Typically, the first information comprises higher layer signaling.

In one embodiment, the first information is a Radio Resource Control (RRC) layer signaling.

In one embodiment, the first information is an RRC Information Element (IE).

In one embodiment, a name of the RRC IE includes CSI-Report.

In one embodiment, a name of the RRC IE includes ReportConfig.

In one embodiment, the first information comprises a CSI-ReportConfig IE.

Typically, a first-type time-frequency resource and a second-type time-frequency resource each comprise a plurality of Resource Elements (REs).

Typically, a first-type time-frequency resource and a second-type time-frequency resource are respectively used for transmitting reference signals of two different cells.

In the present application, an SSB is also referred to as a reference signal.

In one embodiment, each of the first-type time-frequency resource and the second-type time-frequency resource is a CSI Resource.

In one embodiment, the first-type time-frequency resource is an NZP CSI-RS resource, or is a Synchronization Signal/Physical Broadcast CHannel block (SSB) resource indicated by a ssb-Index.

In one embodiment, the second-type time-frequency resource is a Synchronization Signal/Physical Broadcast CHannel block (SSB) resource indicated by a ssb-Index.

In one embodiment, the second-type time-frequency resource is an NZP CSI-RS resource, or is a Synchronization Signal/Physical Broadcast CHannel block (SSB) resource indicated by a ssb-Index.

Typically, there exist multiple second-type time-frequency resources in the second time-frequency resource set other than the second time-frequency resource subset.

Typically, a Physical layer Cell Identity (PCI) of a cell with which any first-type time-frequency resource in the first time-frequency resource set is associated is different from a PCI of a cell with which any second-type time-frequency resource in the second time-frequency resource set is associated.

In one embodiment, any first-type time-frequency resource in the first time-frequency resource set is associated with a first cell, and any second-type time-frequency resource in the second time-frequency resource set is associated with a cell other than the first cell.

In one embodiment, when a first-type time-frequency resource or a second-type time-frequency resource is assigned to a cell, the first-type time-frequency resource or the second-type time-frequency resource is associated with the cell.

In one embodiment, when a PCI of a cell is used to generate an RS sequence of Reference Signals (RS) transmitted in a first-type time-frequency resource or an RS sequence of RS transmitted in a second-type time-frequency resource, the first-type time-frequency resource or the second-type time-frequency resource is associated with the cell.

In one subembodiment, the RS is a Channel Status Information Reference Signal (CSI-RS) or, alternatively, the RS is a Synchronization Signal/Physical Broadcast CHannel block (SSB) and the RS sequence comprises a Primary synchronization signal (PSS) and a Secondary synchronization signal (SSS).

In one embodiment, when a first-type time-frequency resource or a second-type time-frequency resource has Quasi co-location (QCL) with an SSB indicated by any ssb-Index of a cell, the first-type time-frequency resource or the second-type time-frequency resource is associated with the cell.

In one subembodiment, a type of the QCL includes at least Doppler shift.

In one subembodiment, a type of the QCL is at least one of TypeA, TypeB or TypeC.

In one embodiment, when a signal on a first-type time-frequency resource or a signal on a second-type time-frequency resource is synchronized with a cell in downlink, the first-type time-frequency resource or the second-type time-frequency resource is associated with the cell.

In one embodiment, when a signal on a first-type time-frequency resource or a signal on a second-type time-frequency resource is an SSB of a cell, the first-type time-frequency resource or the second-type time-frequency resource is associated with the cell.

In one embodiment, when a signal on a first-type time-frequency resource or a signal on a second-type time-frequency resource is transmitted on a cell, the first-type time-frequency resource or the second-type time-frequency resource is associated with the cell.

In one embodiment, the first-type time-frequency resource is one of an SSB indicated by a ssb-Index or a CSI-RS resource; the second-type time-frequency resource is one of an SSB indicated by a ssb-Index, or a CSI-RS resource, or a Channel State Information-Interference Measurement (CSI-IM).

In one embodiment, the first measurement information set occupies only one physical layer channel.

In one embodiment, a physical layer channel occupied by the first resource indicator is different from a physical layer channel occupied by the second resource indicator.

In one subembodiment, the second resource indicator occupies a same physical layer channel as the first CQI.

In one subembodiment, a feedback period of the first resource indicator is greater than a feedback period of the second resource indicator.

In one embodiment, a physical layer channel occupied by the first resource indicator is different from a physical layer channel occupied by the first CQI.

In one subembodiment, the second resource indicator occupies a same physical layer channel as the first resource indicator.

In one subembodiment, a feedback period of the first resource indicator is the same as a feedback period of the second resource indicator, and both are greater than a feedback period of the first CQI.

The above two embodiments can reduce overhead and improve transmission efficiency.

In one embodiment, the physical layer channel is a Physical Uplink Control Channel (PUCCH).

In one embodiment, the physical layer channel is a Physical Uplink Shared Channel (PUSCH).

In one embodiment, the first resource indicator is a CSI-RS Resource indicator (CRI).

In one embodiment, the first resource indicator is a SSB Resource Indicator (SSBRI).

In one embodiment, the second resource indicator comprises a bitmap, each bit in the bitmap indicating whether a second-type time-frequency resource in the second time-frequency resource set belongs to the second time-frequency resource subset.

In one embodiment, the second resource indicator comprises M indicators, the M indicators respectively indicating M second-type time-frequency resources from the second time-frequency resource set, the second time-frequency resource subset being comprised of the M second-type time-frequency resources, M being a positive integer.

In one embodiment, each of the M indicators is a CRI or SSBRI.

In one embodiment, the first time-frequency resource set is comprised of all CSI resources in a csi-RS-ResourceSetList.

In one embodiment, the first time-frequency resource set is comprised of all CSI resources in a CSI Resource Set.

In one embodiment, the first time-frequency resource set is indicated by a CSI-ResourceConfig IE in the first information.

In one subembodiment of the above three embodiments, the second time-frequency resource set is comprised of all CSI resources in a csi-RS-ResourceSetList.

In one subembodiment of the above three embodiments, the second time-frequency resource set is comprised of all CSI resources in a CSI Resource Set.

In one one subembodiment of the above three embodiments, the second time-frequency resource set is indicated by a CSI-ResourceConfig IE in the first information.

In one embodiment, the type of the CSI resource is periodic or semi-persistent.

In one embodiment, how the first CQI is calculated is related to algorithm of a receiver of the first node, e.g. it is determined based on a BLER (i.e., BLock Error Rate) vs. white noise (dB) curve.

In one embodiment, the first node firstly pre-processes results of the channel measurement and the interference measurement, and then determines the first CQI by means of looking up in a table.

In one embodiment, the pre-processing comprises decomposing a MIMO (Multiple Input Multiple Output) channel into an Eigen-Channel.

In one embodiment, the pre-processing comprises Whitening interference.

In one embodiment, the first CQI is a largest CQI index that satisfies the condition as follows: with a Modulation and Coding scheme (MCS) and a Transport Block Size (TBS) indicated by the CQI index and occupying a CSI reference resource, a probability of error of a transmission block (TB) does not exceed a specific threshold.

In one embodiment, the specific threshold is 0.1.

In one embodiment, the specific threshold is 0.00001.

In one embodiment, the first information indicates multiple time-frequency resource sets, the second time-frequency resource set is one of the multiple time-frequency resource sets, and the first resource indicator is used to determine the second time-frequency resource set from the multiple time-frequency resource sets.

The above method enables interference avoidance related configurations to be carried out independently for specific beams, which can further improve transmission performance.

Typically, the order of positions of the multiple time-frequency resource sets in a configuration signaling is in one-to-one correspondence with the order of the first-type time-frequency resources in the first time-frequency resource set in the configuration signaling.

### Embodiment 2

Embodiment 2 illustrates a schematic diagram of a network architecture according to one embodiment of the present application, as shown in FIG. 2. FIG. 2 illustrates an architecture of 5G New Radio (NR), Long-Term Evolution (LTE) and Long-Term Evolution Advanced (LTE-A) systems. The 5G NR or LTE network architecture 200 may be called a 5G System/Evolved Packet System (5GS/EPS) or other suitable terminology. The EPS 200 may comprise one UE 201, an NG-RAN 202, an Evolved Packet Core/5G-Core Network (EPC-5G-CN) 210, a Home Subscriber Server (HSS) 220 and an Internet Service 230. The EPS 200 may be interconnected with other access networks. For simple description, the entities/interfaces are not shown. As shown in FIG. 2, the EPS 200 provides packet switching services. Those skilled in the art will find it easy to understand that various concepts presented throughout the present application can be extended to networks providing circuit switching services or other cellular networks. The NG-RAN 202 comprises an NR node B (gNB) 203 and other gNBs 204. The gNB 203 provides UE 201 oriented user plane and control plane terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the EPC/5G-CN 210 for the UE 201. Examples of UE 201 include cellular phones, smart phones, Session Initiation Protocol (SIP) phones, laptop computers, Personal Digital Assistant (PDA), Satellite Radios, non-terrestrial base station communications, satellite mobile communications, Global Positioning Systems (GPSs), multimedia devices, video devices, digital audio players (for example, MP3 players), cameras, games consoles, unmanned aerial vehicles, air vehicles, narrow-band physical network equipment, machine-type communication equipment, land vehicles, automobiles, wearable equipment, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the EPC/5G-CN 210 via an S1/NG interface. The EPC/5G-CN 210 comprises a Mobility Management Entity (MME)/Authentication Management Field (AMF)/User Plane Function (UPF) 211, other MMEs/AMFs/UPFs 214, a Service Gateway (S-GW) 212 and a Packet Date Network Gateway (P-GW) 213. The MME/AMF/UPF 211 is a control node for processing a signaling between the UE 201 and the EPC/5G-CN 210. Generally, the MME/AMF/UPF 211 provides bearer and connection management. All user Internet Protocol (IP) packets are transmitted through the S-GW 212. The S-GW 212 is connected to the P-GW 213. The P-GW 213 provides UE IP address allocation and other functions. The P-GW 213 is connected to the Internet Service 230. The Internet Service 230 comprises IP services corresponding to operators, specifically including Internet, Intranet, IP Multimedia Subsystem (IMS) and Packet Switching Streaming (PSS) services.

In one embodiment, the UE 201 corresponds to the first node in the present application, and the gNB203 includes the second node in the present application and the third node in the present application.

In one subembodiment, each of the second node and the third node is a Transmitter Receiver Point (TRP).

In one embodiment, the UE 201 corresponds to the first node in the present application, the gNB203 corresponds to the second node in the present application, and the gNB204 corresponds to the third node in the present application.

In one subembodiment, at least one of the gNB203 or the gNB204 supports Full Duplex.

In one embodiment, the UE 201 is a terminal supporting Massive-MIMO.

In one embodiment, the gNB203 or the gNB204 supports Massive-MIMO-based transmission.

In one embodiment, the gNB 203 or the gNB204 is a MacroCellular base station.

In one embodiment, the gNB203 or the gNB204 is a Micro Cell base station.

In one embodiment, the gNB203 or the gNB204 is a PicoCell base station.

In one embodiment, the gNB203 or the gNB204 is a Femtocell.

In one embodiment, the gNB203 or the gNB204 is a base station supporting large time-delay difference.

In one embodiment, the gNB203 or the gNB204 is a flight platform.

In one embodiment, the gNB203 or the gNB204 is satellite equipment.

In one embodiment, the first node and the second node in the present application both correspond to the UE 201, for instance, V2X communications is performed between the first node and the second node.

### Embodiment 3

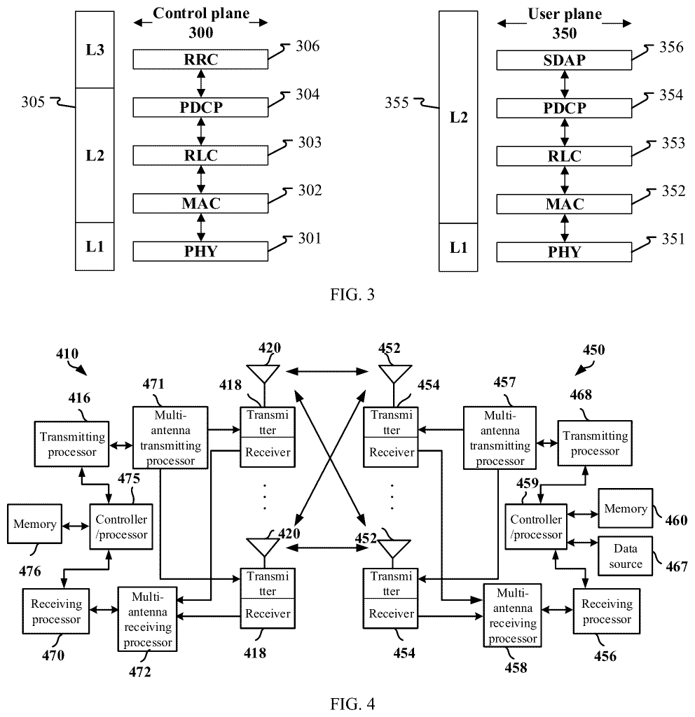

Embodiment 3 illustrates a schematic diagram of an embodiment of a radio protocol architecture of a user plane and a control plane according to the present application, as shown in FIG. 3. FIG. 3 is a schematic diagram illustrating an embodiment of a radio protocol architecture of a user plane 350 and a control plane 300. In FIG. 3, the radio protocol architecture for a control plane 300 between a first node (UE, or RSU in V2X, vehicle-mounted equipment or vehicle-mounted communication module) and a second node (gNB, UE, or RSU in V2X, vehicle-mounted equipment or vehicle-mounted communication module), or between two UEs is represented by three layers, which are: layer 1, layer 2 and layer 3. The layer 1 (L1) is the lowest layer which performs signal processing functions of various PHY layers. The L1 is called PHY 301 in the present application. The layer 2 (L2) 305 is above the PHY 301, and is in charge of the link between a first node and a second node as well as between two UEs via the PHY 301. The L2 305 comprises a Medium Access Control (MAC) sublayer 302, a Radio Link Control (RLC) sublayer 303 and a Packet Data Convergence Protocol (PDCP) sublayer 304. All these sublayers terminate at the second nodes. The PDCP sublayer 304 provides data encryption and integrity protection, and the PDCP sublayer 304 also provides support for inter-cell mobility of the second node between first nodes. The RLC sublayer 303 provides packet segmentation and reassembly, retransmission of a lost packet via ARQ, and it also provides duplicate packet detection and protocol error detection. The MAC sublayer 302 provides mapping between the logical and transport channels and multiplexing of logical channels. The MAC sublayer 302 is also responsible for allocating between first nodes various radio resources (i.e., resource block) in a cell. The MAC sublayer 302 is also in charge of HARQ operation. In the control plane 300, The RRC sublayer 306 in the L3 layer is responsible for acquiring radio resources (i.e., radio bearer) and configuring the lower layer using an RRC signaling between the second node and the first node. The radio protocol architecture in the user plane 350 comprises the L1 layer and the L2 layer. In the user plane 350, the radio protocol architecture used for the first node and the second node in a PHY layer 351, a PDCP sublayer 354 of the L2 layer 355, an RLC sublayer 353 of the L2 layer 355 and a MAC sublayer 352 of the L2 layer 355 is almost the same as the radio protocol architecture used for corresponding layers and sublayers in the control plane 300, but the PDCP sublayer 354 also provides header compression used for higher-layer packet to reduce radio transmission overhead. The L2 layer 355 in the user plane 350 also comprises a Service Data Adaptation Protocol (SDAP) sublayer 356, which is in charge of the mapping between QoS streams and a Data Radio Bearer (DRB), so as to support diversified traffics. Although not described in FIG. 3, the first node may comprise several upper layers above the L2 355, such as a network layer (i.e., IP layer) terminated at a P-GW 213 of the network side and an application layer terminated at the other side of the connection (i.e., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the radio protocol architecture in FIG. 3 is applicable to the third node in the present application.

In one embodiment, the first backhaul signaling or the second backhaul signaling in the present application is generated by the PHY 301.

In one embodiment, the first backhaul signaling or the second backhaul signaling in the present application is generated by the MAC sublayer 302.

In one embodiment, the first information in the present application is generated by the RRC sublayer 306.

In one embodiment, the first measurement information set in the present application is generated by the PHY 301.

### Embodiment 4

Embodiment 4 illustrates a schematic diagram of hardcore modules in a communication node according to one embodiment of the present application, as shown in FIG. 4. FIG. 4 is a block diagram of a first communication device 450 and a second communication device 410 in communication with each other in an access network.

The first communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

The second communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

In a transmission from the second communication device 410 to the first communication device 450, at the second communication device 410, a higher layer packet from a core network is provided to the controller/processor 475. The controller/processor 475 provides functions of the L2 layer. In the transmission from the second communication device 410 to the first communication device 450, the controller/processor 475 provides header compression, encryption, packet segmentation and reordering, and multiplexing between a logical channel and a transport channel, and radio resource allocation of the first communication device 450 based on various priorities. The controller/processor 475 is also in charge of a retransmission of a lost packet and a signaling to the first communication device 450. The transmitting processor 416 and the multi-antenna transmitting processor 471 perform various signal processing functions used for the L1 layer (i.e., PHY). The transmitting processor 416 performs channel coding and interleaving so as to ensure a Forward Error Correction (FEC) at the second communication device 410 side and the mapping to signal clusters corresponding to each modulation scheme (i.e., BPSK, QPSK, M-PSK, and M-QAM, etc.). The multi-antenna transmitting processor 471 performs digital spatial precoding, which includes precoding based on codebook and precoding based on non-codebook, and beamforming processing on encoded and modulated signals to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream, which is later provided to different antennas 420.

In a transmission from the second communication device 410 to the first communication device 450, at the first communication device 450, each receiver 454 receives a signal via a corresponding antenna 452. Each receiver 454 recovers information modulated to the RF carrier, and converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs reception analog precoding/beamforming on a baseband multicarrier symbol stream provided by the receiver 454. The receiving processor 456 converts the processed baseband multicarrier symbol stream from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any first communication device 450-targeted spatial stream. Symbols on each spatial stream are demodulated and recovered in the receiving processor 456 to generate a soft decision. Then the receiving processor 456 de-interleaves and channel decodes the soft decision to recover the higher-layer data and control signal transmitted by the second communication device 410 on the physical channel. Next, the higher-layer data and control signal are provided to the controller/processor 459. The controller/processor 459 provides functions of the L2 layer. The controller/processor 459 can be associated with the memory 460 that stores program code and data; the memory 460 may be called a computer readable medium. In the transmission from the second communication device 410 to the second communication device (node) 450, the controller/processor 459 provides demultiplexing between a transport channel and a logical channel, packet reassembling, decrypting, header decompression and control signal processing so as to recover a higher-layer packet from the core network. The higher-layer packet is later provided to all protocol layers above the L2 layer. Or various control signals can be provided to the L3 for processing.

In a transmission from the first communication device 450 to the second communication device 410, at the first communication device 450, the data source 467 is configured to provide a higher-layer packet to the controller/processor 459. The data source 467 represents all protocol layers above the L2 layer. Similar to a transmitting function of the second communication device 410 described in the transmission from the second communication node 410 to the first communication node 450, the controller/processor 459 performs header compression, encryption, packet segmentation and reordering, and multiplexing between a logical channel and a transport channel based on radio resource allocation so as to provide the L2 layer functions used for the user plane and the control plane. The controller/processor 459 is also responsible for a retransmission of a lost packet, and a signaling to the second communication device 410. The transmitting processor 468 performs channel coding, interleaving and modulation and mapping, and the multi-antenna transmitting processor 457 performs digital multi-antenna spatial precoding, including precoding based on codebook and precoding based on non-codebook, and beamforming. The transmitting processor 468 then modulates generated spatial streams into multicarrier/single-carrier symbol streams. The modulated symbol streams, after being subjected to analog precoding/beamforming in the multi-antenna transmitting processor 457, are provided from the transmitter 454 to each antenna 452. Each transmitter 454 firstly converts a baseband symbol stream provided by the multi-antenna transmitting processor 457 into a radio frequency symbol stream, and then provides the radio frequency symbol stream to the antenna 452.

In a transmission from the first communication device 450 to the second communication device 410, the function of the second communication device 410 is similar to the receiving function of the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and the multi-antenna receiving processor 472 jointly provide functions of the L1 layer. The controller/processor 475 provides functions of the L2 layer. The controller/processor 475 can be associated with the memory 476 that stores program code and data; the memory 476 may be called a computer readable medium. In the transmission from the first communication device 450 to the second communication device 410, the controller/processor 475 provides de-multiplexing between a transport channel and a logical channel, packet reassembling, decrypting, header decompression, control signal processing so as to recover a higher-layer packet from the first communication device (UE) 450. The higher-layer packet coming from the controller/processor 475 may be provided to the core network.

In one embodiment, the first communication device 450 comprises at least one processor and at least one memory. The at least one memory comprises computer program codes; the at least one memory and the computer program codes are configured to be used in collaboration with the at least one processor. The first communication device 450 at least receives first information and transmits a first measurement information set.

In one embodiment, the first communication device 450 comprises a memory that stores a computer readable instruction program. The computer readable instruction program generates actions when executed by at least one processor. The actions include: receiving first information and transmitting a first measurement information set.

In one embodiment, the second communication device 410 comprises at least one processor and at least one memory. The at least one memory comprises computer program codes; the at least one memory and the computer program codes are configured to be used in collaboration with the at least one processor. The second communication device 410 at least transmits first information and receives a first measurement information set.

In one embodiment, the second communication device 410 comprises a memory that stores a computer readable instruction program. The computer readable instruction program generates actions when executed by at least one processor. The actions include: transmitting first information and receiving a first measurement information set.

In one embodiment, the second communication device 410 comprises at least one processor and at least one memory. The at least one memory comprises computer program codes; the at least one memory and the computer program codes are configured to be used in collaboration with the at least one processor. The second communication device 410 at least receives a first backhaul signaling via an air interface and transmits a second backhaul signaling via an air interface.

In one embodiment, the second communication device 410 comprises a memory that stores a computer readable instruction program. The computer readable instruction program generates actions when executed by at least one processor. The actions include: receiving a first backhaul signaling via an air interface and transmitting a second backhaul signaling via an air interface.

In one embodiment, the first communication device 450 corresponds to the first node in the present application.

In one embodiment, the second node of the present application and the third node of the present application are respectively structured employing the second communication device 410.

In one embodiment, the first communication device 450 is a UE.

In one embodiment, the first communication device 450 is a base station.

In one embodiment, the second communication device 410 is a UE.

In one embodiment, the second communication device 410 is a base station.

In one embodiment, the antenna 452, the receiver 454, the multi-antenna receiving processor 458, the receiving processor 456, and the controller/processor 459 are used for receiving the first information.

In one embodiment, the antenna 452, the receiver 454, the multi-antenna receiving processor 458, the receiving processor 456, and the controller/processor 459 are used for performing channel measurement and interference measurement.

In one embodiment, the antenna 452, the transmitter 454, the multi-antenna transmitting processor 457, the transmitting processor 468, and the controller/processor 459 are used for transmitting the first measurement information set.

In one embodiment, the antenna 420, the transmitter 418, the multi-antenna transmitting processor 471, the transmitting processor 416, and the controller/processor 475 are used for transmitting the first information.

In one embodiment, the antenna 420, the transmitter 418, the multi-antenna transmitting processor 471, the transmitting processor 416, and the controller/processor 475 are used for transmitting the first backhaul signaling.

In one embodiment, the antenna 420, the receiver 418, the multi-antenna receiving processor 472, the receiving processor 470, and the controller/processor 475 are used for receiving the first measurement information set.

In one embodiment, the antenna 420, the receiver 418, the multi-antenna receiving processor 472, the receiving processor 470, and the controller/processor 475 are used for receiving the second backhaul signaling.

### Embodiment 5

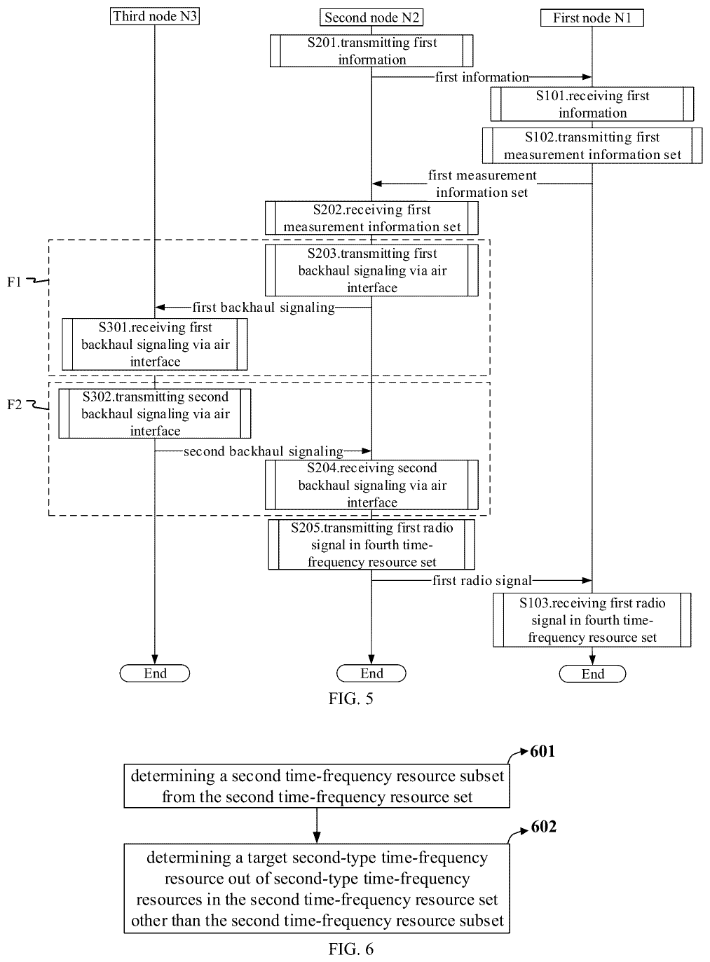

Embodiment 5 illustrates a flowchart of transmissions between a first node, a second node and a third node according to one embodiment of the present application, as shown in FIG. 5. In FIG. 5, steps marked by the box F1 and the box F2 are optional, respectively.

The first node N1 receives first information in step S101, the first information indicating at least a first time-frequency resource set and a second time-frequency resource set, where the first time-frequency resource set comprises at least a target first-type time-frequency resource and the second time-frequency resource set comprises multiple second-type time-frequency resources; and transmits a first measurement information set in step S102, the first measurement information set comprising at least a first resource indicator, a second resource indicator and a first CQI; and receives a first radio signal in a fourth time-frequency resource set; where an interference that the first radio signal undergoes is unrelated to the interference measured in the second time-frequency resource subset.

The second node N2 transmits the first information in step S201; and receives the first measurement information set in step S202; and transmits a first backhaul signaling via an air interface in step S203, the first backhaul signaling being used to avoid an interference measured in the second time-frequency resource subset on a fourth time-frequency resource set; and receives a second backhaul signaling via an air interface in step S204, the first backhaul signaling being used to trigger the second backhaul signaling; and transmits the first radio signal in the fourth time-frequency resource set in step S205.

The third node N3 receives the first backhaul signaling via an air interface in step S301; and transmits the second backhaul signaling via an air interface in step S302.

In Embodiment 5, the first resource indicator is used to indicate the target first-type time-frequency resource, while the second resource indicator is used to indicate a second time-frequency resource subset, the second time-frequency resource subset comprising at least one second-type time-frequency resource, any second-type time-frequency resource in the second time-frequency resource subset belonging to the second time-frequency resource set; a channel measurement performed on the target first-type time-frequency resource is used to calculate the first CQI, and an interference measurement performed on at least one second-type time-frequency resource in the second time-frequency resource set other than the second time-frequency resource subset is used to calculate the first CQI; a cell with which any first-type time-frequency resource in the first time-frequency resource set is associated is different from a cell with which any second-type time-frequency resource in the second time-frequency resource set is associated; the second resource indicator is used to generate the first backhaul signaling; an interference that the first radio signal undergoes is unrelated to the interference measured in the second time-frequency resource subset.

In one embodiment, the second node N2 transmits a reference signal in the first time-frequency resource set and the third node N3 transmits a reference signal in the second time-frequency resource set.

In one embodiment, the first CQI is used to determine an MCS of the first radio signal.

In one embodiment, the first time-frequency resource set, the second time-frequency resource set, and the third time-frequency resource set are simultaneously used to measure Other Interference Signal, the Other Interference Signal being used to calculate the first CQI.

In one embodiment, the Other Interference includes background noise.

In one embodiment, the Other Interference includes interference caused by signals sent by a base station other than the second node N2 and the third node N3.

In one embodiment, the other interference includes interference from other wireless systems other than the cellular network.

Exactly how a determination is made depends on the scheduling algorithm of the second node N2, for example, the MCS of the first radio signal is an MCS having the highest spectral efficiency not higher than the first CQI, or, for example the MCS of the first radio signal is an MCS having the highest spectral efficiency not higher than a first reference CQI, and the first reference CQI is equal to the first CQI plus a first offset, the interference between multi-user MIMO or ACK/NACK-based outer-loop control being used to determine the first offset.

In one embodiment, the first node N1, the second node N2 and the third node N3 are a UE, an NG-RAN node and another NG-RAN node, respectively.

In one embodiment, the first backhaul signaling and the second backhaul signaling are both physical layer signalings.

In one embodiment, the first backhaul signaling and the second backhaul signaling each comprise a Medium Access Control (MAC) Control Element (CE).

The above two embodiments can reduce the delay of inter-base station interaction, making inter-base station collaboration faster and reducing interference.

In one embodiment, the third node N3 transmits a reference signal on any second-type time-frequency resource in the second time-frequency resource subset.

In one embodiment, the phrase that the first backhaul signaling being used to avoid an interference measured in the second time-frequency resource subset on a fourth time-frequency resource set comprises: the first backhaul signaling is used to request or indicate that the third node N3 should avoid adopting a transmission (Tx) spatial parameter on any of second-type time-frequency resources of the second time-frequency resource subset on a fourth time-frequency resource set.

In one embodiment, the transmission (Tx) spatial parameter comprises an analog beamforming vector.

In one embodiment, the transmission (Tx) spatial parameter comprises a digital beamforming vector.

In one embodiment, the transmission (Tx) spatial parameter comprises a spatial filtering parameter.

In one embodiment, the phrase the first backhaul signaling being used to avoid an interference measured in the second time-frequency resource subset on a fourth time-frequency resource set comprises: the first backhaul signaling is used to request or indicate that the third node N3 should avoid transmitting a signal in a fourth time-frequency resource set that is QCL with any of second-type time-frequency resources of the second time-frequency resource subset.

In one embodiment, the second backhaul signaling is used to acknowledge avoidance of the interference measured in the second time-frequency resource subset on at least part of time-frequency resources of the fourth time-frequency resource set.

In one embodiment, the second backhaul signaling is used to acknowledge avoidance of the interference measured in the second time-frequency resource subset on the fourth time-frequency resource set.

In one embodiment, the second backhaul signaling is used to indicate that the third node N3 should avoid transmitting a signal in a fourth time-frequency resource set that is QCL with any of second-type time-frequency resources of the second time-frequency resource subset.

In one embodiment, the second backhaul signaling is used to indicate that the third node N3 should not transmit a signal in a fourth time-frequency resource set, or should transmit a signal that is non-QCL with any of second-type time-frequency resources of the second time-frequency resource subset.

In one embodiment, the second backhaul signaling is used to acknowledge that a request of the first backhaul signaling is granted.

In one embodiment, a channel occupied by the first radio signal includes a Downlink Shared CHannel (DL-SCH).

In one embodiment, a channel occupied by the first radio signal includes a Physical Downlink Shared CHannel (PDSCH).

In one embodiment, a channel occupied by the first radio signal includes a Physical Downlink Control CHannel (PDCCH).

In one embodiment, a channel occupied by the first radio signal includes a PDCCH and a PDSCH.

In one embodiment, time-frequency resources occupied by the first backhaul signaling implicitly indicate time-frequency resources occupied by the second backhaul signaling.

In one embodiment, time-frequency resources occupied by the second backhaul signaling are associated with time-frequency resources occupied by the first backhaul signaling.

In one embodiment, the first radio signal occupies only part of the time-frequency resources in the fourth time-frequency resource set.

In one embodiment, the fourth time-frequency resource set is allocated to a plurality of UEs, the first node N1 being a UE of the plurality of UEs.

In one embodiment, the first backhaul signaling indicates at least the second time-frequency resource subset.

In one embodiment, the second node N2 determines a second-type time-frequency resource in a second time-frequency resource set indicated in the first backhaul signaling according to its own scheduling algorithm, the second resource indicator being used as input of the scheduling algorithm.

In one embodiment, the scheduling algorithm also uses a subset of second-type time-frequency resources reported by a UE other than the first node N1 as input.

In one embodiment, interference measurements performed on all second-type time-frequency resources in the second time-frequency resource set other than the second time-frequency resource subset are used to calculate the first CQI.

In one subembodiment, interference measurements are performed separately on all second-type time-frequency resources in the second time-frequency resource set other than the second time-frequency resource subset, and an average value of interference signals obtained from all the interference measurements is used to calculate the first CQI.

In one embodiment, the first node N1 determines a target second-type time-frequency resource out of second-type time-frequency resources in the second time-frequency resource set other than the second time-frequency resource subset; herein, an interference measurement performed on only the target second-type time-frequency resource among multiple second-type time-frequency resources in the second time-frequency resource set other than the second time-frequency resource subset is used to calculate the first CQI.

In one embodiment, the first node N1 determines by itself the target second-type time-frequency resource.

In one embodiment, the first node N1 randomly determines the target second-type time-frequency resource.

In one embodiment, the target second-type time-frequency resource is selected in such a way that a CQI index calculated with any one of second-type time-frequency resources in the second time-frequency resource set other than the second time-frequency resource subset being used for interference measurement is not less than the first CQI.

The above method ensures that the first CQI is a Low bound CQI, thus ensuring the robustness of the first radio signal.

In one embodiment, the first node N1 selects a second-type time-frequency resource where a strongest amount of interference is measured from second-type time-frequency resources in the second time-frequency resource set other than the second time-frequency resource subset as the target second-type time-frequency resource.

In one embodiment, the first measurement information set comprises the amount of interference measured on the target second-type time-frequency resource.

An advantage of the above embodiment is to assist the second node in determining whether the number of second-type time-frequency resources included in the second time-frequency resource subset is suitable.

The above embodiment avoids calculating a CQI index for each second-type time-frequency resource, reducing the CSI Processing Unit (CPU) occupancy.

In one embodiment, the amount of interference comprises a Reference Signal Received Power (RSRP) of the occupying cell.

In one embodiment, the amount of interference comprises a Reference Signal Received Quality (RSRQ) of the occupying cell.

In one embodiment, the amount of interference comprises a Signal to Interference Noise Ratio (SINR), the SINR being for a signal sent by the occupying cell.

In one embodiment, the occupying cell is maintained by the second node N2.

In one embodiment, all second-type time-frequency resources in the second time-frequency resource set other than the second time-frequency resource subset are occupied by a same cell, i.e., corresponding to the same occupying cell.

In one embodiment, an occupying cell corresponding to any second-type time-frequency resource in the second time-frequency resource set other than the second time-frequency resource subset is maintained by a network-side device other than the second node N2, and an occupying cell corresponding to at least one second-type time-frequency resource present in the second time-frequency resource set other than the second time-frequency resource subset is maintained by a network-side device other than the third node N3.

The above embodiment is advantageous in that interference from a plurality of NG-RAN nodes can be avoided at the same time, further improving transmission performance.

In one embodiment, the first information indicates a third time-frequency resource set, the third time-frequency resource set comprising at least a target third-type time-frequency resource, the target first-type time-frequency resource being associated with the target third-type time-frequency resource; an interference measurement performed on the target third-type time-frequency resource is used to calculate the first CQI.

Typically, the target third-type time-frequency resource is used to measure interference from an Interference Transmission Layer.

Typically, the third time-frequency resource set comprises multiple third-type time-frequency resources, the target third-type time-frequency resource being one of the multiple third-type time-frequency resources.

The above method enables the first node to reasonably generate a first CQI based on unavoidable interference, improving decoding correctness.

In one embodiment, a number of third-type time-frequency resources included in the third time-frequency resource set is the same as a number of first-type time-frequency resources included in the first time-frequency resource set.

In one subembodiment, the third-type time-frequency resources correspond to the first-type time-frequency resources respectively in the order of positions in the third time-frequency resource set and the order of positions in the first time-frequency resource set.

In one embodiment, the third time-frequency resource set is a CSI resource set.

In one embodiment, any third-type time-frequency resource in the third time-frequency resource set is a CSI-IM resource, or a CSI-RS resource.

In one embodiment, any third-type time-frequency resource in the third time-frequency resource set is configured by a csi-IM-Resource or an nzp-CSI-RS-Resource.

Typically, any third-type time-frequency resource in the third time-frequency resource set is associated with an SSB or a CSI-RS resource of a first cell, or, alternatively, is a CSI-IM resource; at least one first-type time-frequency resource in the first time-frequency resource set is associated with the first cell.

In one embodiment, all first-type time-frequency resources in the first time-frequency resource set are associated with the first cell.

In one embodiment, the first information indicates the type of CSI included in the first measurement information set.

In one embodiment, the type of CSI included in the first measurement information set is indicated by a reportQuantity in the first information.

### Embodiment 6

Embodiment 6 illustrates a schematic diagram of determining a target second-type time-frequency resource according to one embodiment of the present application. The step 601 and step 602 in FIG. 6 are performed in the first node, where the step 601 is optional.

The first node determines a second time-frequency resource subset from the second time-frequency resource set in step 601; and determines a target second-type time-frequency resource out of second-type time-frequency resources in the second time-frequency resource set other than the second time-frequency resource subset in step 602.

In Embodiment 6, an interference measurement performed on only the target second-type time-frequency resource among multiple second-type time-frequency resources in the second time-frequency resource set other than the second time-frequency resource subset is used to calculate the first CQI.

Typically, how a second time-frequency resource subset is determined from the second time-frequency resource set depends on the implementation of the first node, and several non-restrictive implementations are given below.

In one embodiment, the second time-frequency resource subset comprises at least one second-type time-frequency resource, and the first node randomly selects from the second time-frequency resource set a second-type time-frequency resource belonging to the second time-frequency resource subset.

In one embodiment, the second time-frequency resource subset comprises at least one second-type time-frequency resource, for any second-type time-frequency resource in the second time-frequency resource subset and any second-type time-frequency resource in the second time-frequency resource set other than the second time-frequency resource subset, a CQI index calculated based on an amount of interference measured on the former is not greater than a CQI index calculated based on an amount of interference measured on the latter.

The above method avoids the strongest interference and improves transmission performance.

In one embodiment, the second time-frequency resource subset comprises at least one second-type time-frequency resource, and an amount of interference measured on any second-type time-frequency resource in the second time-frequency resource subset is stronger than an amount of interference measured on any second-type time-frequency resource in the second time-frequency resource set other than the second time-frequency resource subset.

The above method avoids a large quantity of CQI calculations and reduces CPU occupancy.

In one embodiment, the amount of interference comprises an RSRP of an occupying cell.

In one embodiment, the amount of interference comprises an RSRQ of an occupying cell.

In one embodiment, the amount of interference comprises a SINR, the SINR being for a signal sent by the occupying cell.

In one embodiment, the occupying cell is maintained by the second node N2.

In one embodiment, all second-type time-frequency resources in the second time-frequency resource set other than the second time-frequency resource subset are occupied by a same cell, i.e., corresponding to the same occupying cell.

In one embodiment, a number of second-type time-frequency resources included in the second time-frequency resource subset is configurable.

In one embodiment, the first information indicates the number of second-type time-frequency resources included in the second time-frequency resource subset.

### Embodiment 7

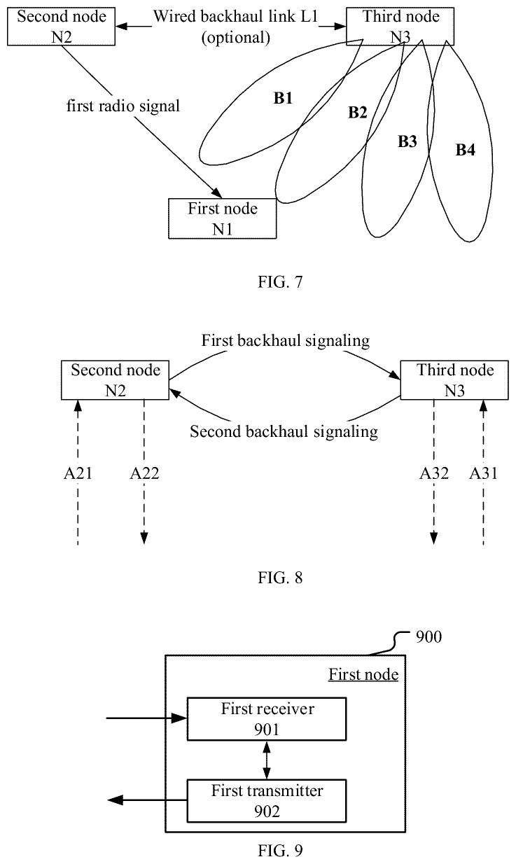

Embodiment 7 illustrates a schematic diagram of CQI calculation according to another embodiment of the present application, as shown in FIG. 7.

In Embodiment 7, a second time-frequency resource set comprises four second-type time-frequency resources, and the third node N3 transmits a reference signal using 4 spatial transmission parameter groups B1, B2, B3, and B4, respectively, on the four second-type time-frequency resources.

The second resource indicator fed back by a first node N1 is used to indicate two second-type time-frequency resources occupied by the spatial transmission parameter groups B1 and B2, i.e. a second time-frequency resource subset, from among the four second-type time-frequency resources.

A second node N2 generates a first backhaul signaling based on at least the second resource indicator and then sends the first backhaul signaling to the third node N3 via an air interface.

The interference measurement performed on at least one of the 2 second-type time-frequency resources employing the spatial transmission parameter groups B3 and B4 are used to calculate a first CQI, the first CQI being used to determine an MCS of the first radio signal, and on time-frequency resources where the second node N2 transmits the first radio signal, the third node N3 avoids employing the spatial transmission parameters B1 and B2. This significantly reduces the interference to the first radio signal.

In one embodiment, each spatial transmission parameter group is indexed by a TCI-state.

In one embodiment, each spatial transmission parameter group is indexed by a ssb-index.

In one embodiment, on time-frequency resources where the second node N2 transmits a first radio signal, the first node N3 uses the spatial transmission parameters B3 and B4 for the transmission of the radio signal.

In one embodiment, there exists a wired backhaul link L1 between the second node N2 and the third node N3, and before transmitting the first information, the second node N2 and the third node N3 make necessary configuration via the wired backhaul link L1.

In one embodiment, the necessary configuration comprises the second time-frequency resource set, or the fourth time-frequency resource set.

In one embodiment, the necessary configuration comprises time-frequency resources occupied by the first backhaul signaling, or time-frequency resources occupied by the second backhaul signaling.

In one embodiment, the wired backhaul link L1 supports an Xn interface.

### Embodiment 8

Embodiment 8 illustrates a schematic diagram of backhaul signaling according to one embodiment of the present application, as shown in FIG. 8. FIG. 8 depicts a full-duplex mode of operation.

In one embodiment, a transmission of the first backhaul signaling is temporally overlapped with an uplink reception (as shown by arrow A21) of the second node N2, and a reception of the first backhaul signaling is temporally overlapped with an uplink reception (as shown by arrow A31) of the third node N3; i.e., the second node N2 transmits the first backhaul signaling in a full-duplex manner.

In one embodiment, a transmission of the first backhaul signaling is temporally overlapped with a downlink transmission (as shown by arrow A22) of the second node N2, and a reception of the first backhaul signaling is temporally overlapped with a downlink transmission (as shown by arrow A32) of the third node N3; i.e., the third node N3 receives the first backhaul signaling in a full-duplex manner.

In one embodiment, a reception of the second backhaul signaling is temporally overlapped with an uplink reception (as shown by arrow A21) of the second node N2, and a transmission of the second backhaul signaling is temporally overlapped with an uplink reception (as shown by arrow A31) of the third node N3; i.e., the third node N3 transmits the second backhaul signaling in a full-duplex manner.

In one embodiment, a reception of the second backhaul signaling is temporally overlapped with a downlink transmission (as shown by arrow A22) of the second node N2, and a transmission of the second backhaul signaling is temporally overlapped with a downlink transmission (as shown by arrow A32) of the third node N3; i.e., the second node N2 receives the first backhaul signaling in a full-duplex manner.

### Embodiment 9

Embodiment 9 illustrates a structure block diagram of a processing device used in a first node according to one embodiment of the present application, as shown in FIG. 9. In FIG. 9, a processing device 900 in a first node is comprised of a first receiver 901 and a first transmitter 902; the first node 900 is a UE.

The first receiver 901 receives first information, the first information indicating at least a first time-frequency resource set and a second time-frequency resource set, where the first time-frequency resource set comprises at least a target first-type time-frequency resource and the second time-frequency resource set comprises multiple second-type time-frequency resources;
the first transmitter 902 transmits a first measurement information set, the first measurement information set comprising at least a first resource indicator, a second resource indicator and a first CQI.

In Embodiment 9, the first resource indicator is used to indicate the target first-type time-frequency resource, while the second resource indicator is used to indicate a second time-frequency resource subset, the second time-frequency resource subset comprising at least one second-type time-frequency resource, any second-type time-frequency resource in the second time-frequency resource subset belonging to the second time-frequency resource set; a channel measurement performed on the target first-type time-frequency resource is used to calculate the first CQI, and an interference measurement performed on at least one second-type time-frequency resource in the second time-frequency resource set other than the second time-frequency resource subset is used to calculate the first CQI; a cell with which any first-type time-frequency resource in the first time-frequency resource set is associated is different from a cell with which any second-type time-frequency resource in the second time-frequency resource set is associated.

Typically, the interference measurement performed on at least one second-type time-frequency resources in the second time-frequency resource set other than the second time-frequency resource subset includes measuring a reference signal transmitted from a non-serving cell.

Typically, the interference measurement performed on at least one second-type time-frequency resources in the second time-frequency resource set other than the second time-frequency resource subset includes measuring a reference signal transmitted from a non-serving NG-RAN node.

In one embodiment, the first receiver 901 determines a target second-type time-frequency resource out of second-type time-frequency resources in the second time-frequency resource set other than the second time-frequency resource subset; herein, an interference measurement performed on only the target second-type time-frequency resource among multiple second-type time-frequency resources in the second time-frequency resource set other than the second time-frequency resource subset is used to calculate the first CQI.

In one embodiment, the first information indicates a third time-frequency resource set, the third time-frequency resource set comprising at least a target third-type time-frequency resource, the target first-type time-frequency resource being associated with the target third-type time-frequency resource; an interference measurement performed on the target third-type time-frequency resource is used to calculate the first CQI; each non-zero power (NZP) CSI-RS resource in the third time-frequency resource set is used to measure interference from an Interference Transmission Layer (ITL).

In one embodiment, the target second-type time-frequency resource is a second-type time-frequency resource where a strongest amount of interference is measured among second-type time-frequency resources in the second time-frequency resource set other than the second time-frequency resource subset.

In one embodiment, the first measurement information set comprises the amount of interference measured on the target second-type time-frequency resource.

In one embodiment, the first receiver 901 determines a second time-frequency resource subset from the second time-frequency resource set.

In one embodiment, the second resource indicator is used to generate the first backhaul signaling, the first backhaul signaling being used to avoid an interference measured in the second time-frequency resource subset on a fourth time-frequency resource set.

In one embodiment, the first receiver 901 receives a first radio signal in the fourth time-frequency resource set; herein, an interference that the first radio signal undergoes is unrelated to the interference measured in the second time-frequency resource subset.

In one embodiment, the first transmitter 902 comprises at least one of the antenna 452, the transmitter/receiver 454, the multi-antenna transmitting processor 457, the transmitting processor 468, the controller/processor 459, the memory 460 or the data source 467 in FIG. 4 of the present application.

In one embodiment, the first transmitter 902 comprises the antenna 452, the transmitter/receiver 454, the multi-antenna transmitting processor 457, the transmitting processor 468, the controller/processor 459, the memory 460 and the data source 467 in FIG. 4 of the present application.

In one embodiment, the first receiver 901 comprises at least the first five of the antenna 452, the receiver 454, the multi-antenna receiving processor 458, the receiving processor 456, the controller/processor 459, the memory 460 and the data source 467 in FIG. 4 of the present application.

In one embodiment, the first receiver 901 comprises at least the first four of the antenna 452, the receiver 454, the multi-antenna receiving processor 458, the receiving processor 456, the controller/processor 459, the memory 460 and the data source 467 in FIG. 4 of the present application.

In one embodiment, the first receiver 901 comprises at least the first three of the antenna 452, the receiver 454, the multi-antenna receiving processor 458, the receiving processor 456, the controller/processor 459, the memory 460 and the data source 467 in FIG. 4 of the present application.

### Embodiment 10

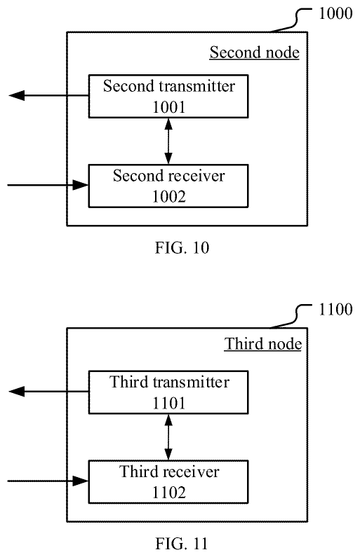

Embodiment 10 illustrates a structure block diagram of a processing device used in a second node according to one embodiment of the present application, as shown in FIG. 10. In FIG. 10, a processing device 1000 in a second node is comprised of a second transmitter 1001 and a second receiver 1002; the second node 1000 is a base station.

The second transmitter 1001 transmits first information, the first information indicating at least a first time-frequency resource set and a second time-frequency resource set, where the first time-frequency resource set comprises at least a target first-type time-frequency resource and the second time-frequency resource set comprises multiple second-type time-frequency resources;
the second receiver 1002 receives a first measurement information set, the first measurement information set comprising at least a first resource indicator, a second resource indicator and a first CQI.

In Embodiment 10, the first resource indicator is used to indicate the target first-type time-frequency resource, while the second resource indicator is used to indicate a second time-frequency resource subset, the second time-frequency resource subset comprising at least one second-type time-frequency resource, any second-type time-frequency resource in the second time-frequency resource subset belonging to the second time-frequency resource set; a channel measurement performed on the target first-type time-frequency resource is used to calculate the first CQI, and an interference measurement performed on at least one second-type time-frequency resource in the second time-frequency resource set other than the second time-frequency resource subset is used to calculate the first CQI; a cell with which any first-type time-frequency resource in the first time-frequency resource set is associated is different from a cell with which any second-type time-frequency resource in the second time-frequency resource set is associated.

In one embodiment, the second transmitter 1001 transmits a first backhaul signaling via an air interface; where the second resource indicator is used to generate the first backhaul signaling, the first backhaul signaling being used to avoid an interference measured in the second time-frequency resource subset on a fourth time-frequency resource set.

In one embodiment, the second receiver 1002 receives a second backhaul signaling via an air interface; where the second backhaul signaling is used to acknowledge avoidance of the interference measured in the second time-frequency resource subset on the fourth time-frequency resource set.

In one embodiment, the second transmitter 1001 transmits a first radio signal in the fourth time-frequency resource set; herein, an interference that the first radio signal undergoes is unrelated to the interference measured in the second time-frequency resource subset.

In one embodiment, the first information indicates a third time-frequency resource set, the third time-frequency resource set comprising at least a target third-type time-frequency resource, the target first-type time-frequency resource being associated with the target third-type time-frequency resource; an interference measurement performed on the target third-type time-frequency resource is used to calculate the first CQI.

In one embodiment, the target second-type time-frequency resource is a second-type time-frequency resource where a strongest RSRP is measured among second-type time-frequency resources in the second time-frequency resource set other than the second time-frequency resource subset.

In one embodiment, the second transmitter 1001 comprises the antenna 420, the transmitter 418, the transmitting processor 416 and the controller/processor 475.

In one embodiment, the second transmitter 1001 comprises the antenna 420, the transmitter 418, the multi-antenna transmitting processor 471, the transmitting processor 416 and the controller/processor 475.

In one embodiment, the second transmitter 1001 comprises the antenna 420, the transmitter 418, the transmitting processor 416 and the controller/processor 475.

In one embodiment, the second transmitter 1001 comprises the antenna 420, the transmitter 418, the multi-antenna transmitting processor 471, the transmitting processor 416 and the controller/processor 475.

In one embodiment, the second receiver 1002 comprises the antenna 420, the receiver 418, the multi-antenna receiving processor 472, the receiving processor 470, and the controller/processor 475.

In one embodiment, the second receiver 1002 comprises the controller/processor 475.

### Embodiment 11

Embodiment 11 illustrates a structure block diagram of a processing device used in a third node according to one embodiment of the present application, as shown in FIG. 11. In FIG. 11, a processing device 1100 in a third node is comprised of a third transmitter 1101 and a third receiver 1102; the third node 1100 is a base station.

The third receiver 1102 receives a first backhaul signaling via an air interface;
the third transmitter 1101 transmits a second backhaul signaling via an air interface.

In Embodiment 11, a second resource indicator is used to generate the first backhaul signaling, the first backhaul signaling being used to avoid an interference measured in the second time-frequency resource subset on a fourth time-frequency resource set; the second resource indicator is used to indicate a second time-frequency resource subset, the second time-frequency resource subset comprising at least one second-type time-frequency resource, any second-type time-frequency resource in the second time-frequency resource subset belonging to a second time-frequency resource set; the second resource indicator belongs to a first measurement information set, the first measurement information set comprising at least a first resource indicator and a first CQI; the first resource indicator is used to indicate a target first-type time-frequency resource, a channel measurement performed on the target first-type time-frequency resource is used to calculate the first CQI, and an interference measurement performed on at least one second-type time-frequency resource in the second time-frequency resource set other than the second time-frequency resource subset is used to calculate the first CQI; the target first-type time-frequency resource belongs to the first time-frequency resource set; a cell with which any first-type time-frequency resource in the first time-frequency resource set is associated is different from a cell with which any second-type time-frequency resource in the second time-frequency resource set is associated; the second backhaul signaling is used to acknowledge avoidance of the interference measured in the second time-frequency resource subset on the fourth time-frequency resource set.

In one embodiment, the first information indicates a third time-frequency resource set, the third time-frequency resource set comprising at least a target third-type time-frequency resource, the target first-type time-frequency resource being associated with the target third-type time-frequency resource; an interference measurement performed on the target third-type time-frequency resource is used to calculate the first CQI.

In one embodiment, the target second-type time-frequency resource is a second-type time-frequency resource where a strongest RSRP is measured among second-type time-frequency resources in the second time-frequency resource set other than the second time-frequency resource subset.

In one embodiment, the third node 1100 is a base station.

In one embodiment, the third transmitter 1101 comprises the antenna 420, the transmitter 418, the transmitting processor 416 and the controller/processor 475.

In one embodiment, the third transmitter 1101 comprises the antenna 420, the transmitter 418, the multi-antenna transmitting processor 471, the transmitting processor 416 and the controller/processor 475.

In one embodiment, the third transmitter 1101 comprises the antenna 420, the transmitter 418, the transmitting processor 416 and the controller/processor 475.

In one embodiment, the third transmitter 1101 comprises the antenna 420, the transmitter 418, the multi-antenna transmitting processor 471, the transmitting processor 416 and the controller/processor 475.

In one embodiment, the third receiver 1102 comprises the antenna 420, the receiver 418, the multi-antenna receiving processor 472, the receiving processor 470, and the controller/processor 475.

In one embodiment, the third receiver 1102 comprises the controller/processor 475.

The ordinary skill in the art may understand that all or part of steps in the above method may be implemented by instructing related hardware through a program. The program may be stored in a computer readable storage medium, for example Read-Only-Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The present application is not limited to any combination of hardware and software in specific forms. The UE and terminal in the present application include but are not limited to unmanned aerial vehicles, communication modules on unmanned aerial vehicles, telecontrolled aircrafts, aircrafts, diminutive airplanes, mobile phones, tablet computers, notebooks, vehicle-mounted communication equipment, wireless sensor, network cards, terminals for Internet of Things (IOT), RFID terminals, NB-IOT terminals, Machine Type Communication (MTC) terminals, enhanced MTC (eMTC) terminals, data cards, low-cost mobile phones, low-cost tablet computers, etc. The base station or system device in the present application includes but is not limited to macro-cellular base stations, micro-cellular base stations, home base stations, relay base station, gNB (NR node B), Transmitter Receiver Point (TRP), and other radio communication equipment.

It will be appreciated by those skilled in the art that this disclosure can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, comprising:
a first receiver, receiving first information, the first information indicating at least a first time-frequency resource set and a second time-frequency resource set, where the first time-frequency resource set comprises at least a target first-type time-frequency resource and the second time-frequency resource set comprises multiple second-type time-frequency resources; and
a first transmitter, transmitting a first measurement information set, the first measurement information set comprising at least a first resource indicator, a second resource indicator and a first CQI;
wherein the first resource indicator is used to indicate the target first-type time-frequency resource, while the second resource indicator is used to indicate a second time-frequency resource subset, the second time-frequency resource subset comprising at least one second-type time-frequency resource, any second-type time-frequency resource in the second time-frequency resource subset belonging to the second time-frequency resource set; a channel measurement performed on the target first-type time-frequency resource is used to calculate the first CQI, and an interference measurement performed on at least one second-type time-frequency resource in the second time-frequency resource set other than the second time-frequency resource subset is used to calculate the first CQI; a cell with which any first-type time-frequency resource in the first time-frequency resource set is associated is different from a cell with which any second-type time-frequency resource in the second time-frequency resource set is associated.

2. The first node according to claim 1, characterized in comprising:
the first receiver, determining a target second-type time-frequency resource out of second-type time-frequency resources in the second time-frequency resource set other than the second time-frequency resource subset;
wherein an interference measurement performed on only the target second-type time-frequency resource among multiple second-type time-frequency resources in the second time-frequency resource set other than the second time-frequency resource subset is used to calculate the first CQI.

3. The first node according to claim 1, characterized in that the first information indicates a third time-frequency resource set, the third time-frequency resource set comprising at least a target third-type time-frequency resource, the target first-type time-frequency resource being associated with the target third-type time-frequency resource; an interference measurement performed on the target third-type time-frequency resource is used to calculate the first CQI.

4. The first node according to claim 2, characterized in that the first information indicates a third time-frequency resource set, the third time-frequency resource set comprising at least a target third-type time-frequency resource, the target first-type time-frequency resource being associated with the target third-type time-frequency resource; an interference measurement performed on the target third-type time-frequency resource is used to calculate the first CQI.

5. The first node according to claim 2, characterized in that a second-type time-frequency resource where a strongest amount of interference is measured is selected from second-type time-frequency resources in the second time-frequency resource set other than the second time-frequency resource subset as the target second-type time-frequency resource.

6. The first node according to claim 3, characterized in that a second-type time-frequency resource where a strongest amount of interference is measured is selected from second-type time-frequency resources in the second time-frequency resource set other than the second time-frequency resource subset as the target second-type time-frequency resource.

7. The first node according to claim 4, characterized in that a second-type time-frequency resource where a strongest amount of interference is measured is selected from second-type time-frequency resources in the second time-frequency resource set other than the second time-frequency resource subset as the target second-type time-frequency resource.

8. The first node according to claim 1, characterized in comprising:
the first receiver, determining a second time-frequency resource subset from the second time-frequency resource set.

9. The first node according to claim 1, characterized in that the second resource indicator is used to generate a first backhaul signaling, the first backhaul signaling being used to avoid an interference measured in the second time-frequency resource subset on a fourth time-frequency resource set.

10. The first node according to claim 9, characterized in comprising:
the first receiver, receiving a first radio signal in the fourth time-frequency resource set;
wherein an interference that the first radio signal undergoes is unrelated to the interference measured in the second time-frequency resource subset.

11. A second node for wireless communications, comprising:
a second transmitter, transmitting first information, the first information indicating at least a first time-frequency resource set and a second time-frequency resource set, where the first time-frequency resource set comprises at least a target first-type time-frequency resource and the second time-frequency resource set comprises multiple second-type time-frequency resources; and
a second receiver, receiving a first measurement information set, the first measurement information set comprising at least a first resource indicator, a second resource indicator and a first CQI;
wherein the first resource indicator is used to indicate the target first-type time-frequency resource, while the second resource indicator is used to indicate a second time-frequency resource subset, the second time-frequency resource subset comprising at least one second-type time-frequency resource, any second-type time-frequency resource in the second time-frequency resource subset belonging to the second time-frequency resource set; a channel measurement performed on the target first-type time-frequency resource is used to calculate the first CQI, and an interference measurement performed on at least one second-type time-frequency resource in the second time-frequency resource set other than the second time-frequency resource subset is used to calculate the first CQI; a cell with which any first-type time-frequency resource in the first time-frequency resource set is associated is different from a cell with which any second-type time-frequency resource in the second time-frequency resource set is associated.

12. The second node according to claim 11, characterized in comprising:
the second transmitter, transmitting a first backhaul signaling via an air interface;
wherein the second resource indicator is used to generate the first backhaul signaling, the first backhaul signaling being used to avoid an interference measured in the second time-frequency resource subset on a fourth time-frequency resource set.

13. The second node according to claim 12, characterized in comprising:
the second receiver, receiving a second backhaul signaling via an air interface;
wherein the second backhaul signaling is used to acknowledge avoidance of the interference measured in the second time-frequency resource subset on the fourth time-frequency resource set.

14. The second node according to claim 11, characterized in comprising:
the second transmitter, transmitting a first radio signal in the fourth time-frequency resource set;
wherein an interference that the first radio signal undergoes is unrelated to the interference measured in the second time-frequency resource subset.

15. The second node according to claim 12, characterized in comprising:
the second transmitter, transmitting a first radio signal in the fourth time-frequency resource set;
wherein an interference that the first radio signal undergoes is unrelated to the interference measured in the second time-frequency resource subset.

16. A third node for wireless communications, comprising:
a third receiver, receiving a first backhaul signaling via an air interface;
wherein a second resource indicator is used to generate the first backhaul signaling, the first backhaul signaling being used to avoid an interference measured in the second time-frequency resource subset on a fourth time-frequency resource set; the second resource indicator is used to indicate a second time-frequency resource subset, the second time-frequency resource subset comprising at least one second-type time-frequency resource, any second-type time-frequency resource in the second time-frequency resource subset belonging to a second time-frequency resource set; the second resource indicator belongs to a first measurement information set, the first measurement information set comprising at least a first resource indicator and a first CQI; the first resource indicator is used to indicate a target first-type time-frequency resource, a channel measurement performed on the target first-type time-frequency resource is used to calculate the first CQI, and an interference measurement performed on at least one second-type time-frequency resource in the second time-frequency resource set other than the second time-frequency resource subset is used to calculate the first CQI; the target first-type time-frequency resource belongs to the first time-frequency resource set; a cell with which any first-type time-frequency resource in the first time-frequency resource set is associated is different from a cell with which any second-type time-frequency resource in the second time-frequency resource set is associated.

17. The third node according to claim 16, characterized in comprising:
a third transmitter, transmitting a second backhaul signaling via an air interface;
wherein the second backhaul signaling is used to acknowledge avoidance of the interference measured in the second time-frequency resource subset on the fourth time-frequency resource set.

18. The third node according to claim 16, characterized in comprising:
the third transmitter, avoiding in the fourth time-frequency resource set a usage of a transmission parameter that is QCL with any second-type time-frequency resource in the second time-frequency resource subset.

19. The third node according to claim 17, characterized in comprising:
the third transmitter, avoiding in the fourth time-frequency resource set a usage of a transmission parameter that is QCL with any second-type time-frequency resource in the second time-frequency resource subset.
